(19) United States
(12) Patent Application Publication
(10) Pub. No.: US 2025/0252229 A1
(43) Pub. Date: Aug. 7, 2025

(54) County Power Distribution Network Gridding Planning Method and System Based on Digital Resource Integration Technology

(71) Applicant: Guizhou Power Grid Co., Ltd., Guiyang (CN)

(72) Inventors: Jie WANG, Guiyang (CN); Fei ZHENG, Guiyang (CN); Ludong CHEN, Guiyang (CN); Jinsen LIU, Guiyang (CN); Ning LUO, Guiyang (CN); Pengcheng ZHANG, Guiyang (CN); Qingyu ZHAO, Guiyang (CN); Mao MIAO, Guiyang (CN); Molin HE, Guiyang (CN); Chang XU, Guiyang (CN); Yan ZHANG, Guiyang (CN); Yu ZHANG, Guiyang (CN); Xinjie HUANG, Guiyang (CN); Shilei XIONG, Guiyang (CN); Maosheng WANG, Guiyang (CN); Lei FANG, Guiyang (CN); Yangquan QU, Guiyang (CN); Lishun YANG, Guiyang (CN); Xingshan XIANG, Guiyang (CN); Shengbai QUAN, Guiyang (CN); Xianping JIA, Guiyang (CN)

(21) Appl. No.: 19/016,925

(22) Filed: Jan. 10, 2025

Related U.S. Application Data
(63) Continuation of application No. PCT/CN2024/138071, filed on Dec. 10, 2024.

(30) Foreign Application Priority Data
Feb. 7, 2024 (CN) 2024101724837

(51) Int. Cl. G06F 30/20; G06F 113/04

(52) U.S. Cl. CPC G06F 30/20; G06F 2113/04

(57) ABSTRACT

Disclosed is a county power distribution network gridding planning method and system based on a digital resource integration technology, comprising: acquiring geographic information of a county region, and conducting primary division of power supply grids; conducting secondary division of the power supply grids by using a K-means clustering algorithm; and selecting an optimal planning strategy and conducting third division of the power supply grids through a self-adaptive multi-target whale optimization algorithm. By studying the development and evolution mechanism of a county power distribution network in terms of time, space and resources, the planning and operation methods of the county power distribution network are combined to carry out resource digital integration, and conduct grid division on the county power distribution network. From the aspect of economy and safety, the multi-target collaboration planning model of the power distribution network is established, and an optimal planning scheme is selected.

### CROSS-REFERENCE TO RELATED APPLICATIONS

The present application claims priority to Chinese Patent Application No. 2024101724837, filed on Feb. 7, 2024, the entire disclosure of which is incorporated herein by reference.

### TECHNICAL FIELD

The present invention relates to the technical field of power network gridding planning, and in particular to a county power distribution network gridding planning method and system based on a digital resource integration technology.

### BACKGROUND

With the rapid advancement of intelligence strategy of power grids, new energy generation such as solar and wind power generation instead of traditional thermal power generation has become a trend. But distributed resource access can bring many challenges and problems to power distribution network planning. Gridding planning is the development direction of power distribution network planning. The idea of gridding is to divide large power distribution networks into small ones, being simple to manage, and operate in different regions, and is an important mode of reducing the control difficulty and dimension of the power distribution networks.

A conventional grid division method is only to divide from the perspective of terrain, without considering the impact of distributed resource access. The method, on the basis of conventional grid division, for different landforms, load operation situations and distributed resource development patterns in different county regions, proposes a county power distribution network gridding planning strategy based on a digital resource integration technology, for scenery, differentiated and standardized planning of a power distribution network.

### SUMMARY

In view of the existing problems above, the present invention is disclosed.

Therefore, the technical problem to be solved by the present invention is that: a conventional county power distribution network gridding planning method has the problems of being high in cost, unreasonable in division, and the like.

To solve the technical problem, the present invention provides the following technical solution: a county power distribution network gridding planning method based on a digital resource integration technology, including:
acquiring geographic information of a county region, and conducting primary division of power supply grids;
conducting secondary division of the power supply grids by means of using a K-means clustering algorithm; and
selecting an optimal planning strategy and conducting third division of the power supply grids through a self-adaptive multi-target whale optimization algorithm.

As a preferable solution of the multi-target county power distribution network grid optimizing method of the present invention, the primary division includes conducting the primary division of the power supply grids on a power grid digital platform according to mountains, water areas, traffic and geographical situations of different functional areas in a county region.

As a preferable solution of the multi-target county power distribution network grid optimizing method of the present invention, the K-means clustering algorithm includes determining a county region clustering number k according to a primary grid division result, with the geometric center of grids as the central point of each cluster;
determining classification conditions, namely taking power supply distances between a transformer substation and a load point and a distributed resource as classification conditions;
comparing each node with a closest clustering center according to a measuring mode of a power supply scope, and distributing into a closest cluster;
re-calculating data points in each cluster, namely the object mean of the nodes of each cluster, and simultaneously calculating the clustering result of all clusters; and
if the result value changes, repeating the step of determining classification conditions, or else ending the algorithm, and outputting a secondary grid division result.

As a preferable solution of the multi-target county power distribution network grid optimizing method of the present invention, the third division includes establishing a county power distribution network gridding multi-target coordination planning model, and solving the multi-target optimization model to achieve the third division;
the county power distribution network gridding multi-target coordination planning model comprises the total cost of grid planning investment:

$${C}_{eco} = \text{?} ( ε {C}_{ij , m} + \text{?} ) + \text{?} [ ( ε \text{?} + \text{?} ) + \text{?} ] + \text{?} + {C}_{op} - {C}_{pro} + \text{?}$$

$$\text{?} \text{indicates text missing or illegible when filed}$$

in the formula, C_{eco} represents the total cost of grid planning investment; ε=k₁+k₂ and k₁ [symbol] k₂ are respectively coefficient of operation and maintenance cost and redemptory investment recovery coefficient; C_{ij,m} represents the total cost of the main line of an m^{th} interstation power supply grid, as the comprehensive cost of the whole line of all main lines; C_{th,n} represents the comprehensive cost of the main line of a self-loop power supply unit in an n^{th} non-interstation power supply grid; C_{fs,n} represents the comprehensive cost of the main line of a radiant power supply unit in the n^{th} non-interstation power supply grid; C_{ij,m}^{xy} represents the annual cost of main line power consumption of the m^{th} interstation power supply grid; C_{fj,n}^{xy} represents the annual cost of main line outage cost of the n^{th} non-interstation power supply grid; Cᵢₙ represents the distributed resource investment construction cost; Cₒₚ represents the distributed resource operation maintenance cost; Cₚᵣₒ represents the distributed resource benefit; Cₗ represents inter-grid digital communication investment;
setting that a communication line is constructed along a power line, each node is equipped with a digital communication substation, and the communication substation is not far away from the transformer substation; setting the digital communication investment as:

$$\text{?} = \text{?} {d}_{m} + {p}_{c} N$$

$$\text{?} \text{indicates text missing or illegible when filed}$$

in the formula, N represents the number of grids; d represents the length of a branch line of a grid m; pₗ represents the unit price of a data transmission line; p_{c} represents the unit price of a grid control unit;
the outage cost describes a power distribution network overall reliability index, expressed as:

$$\text{?} = {\sum }_{m = 1}^{N} {N}_{los} \text{?} [ {\sum }_{n = 1}^{N} {P}_{lo , m , j} ( 1 - {S}_{m , j} ) {P}_{m , j} ( t ) ] dt$$

$$\text{?} \text{indicates text missing or illegible when filed}$$

in the formula, Cₗₒₛ is a power distribution network reliability index, representing the total outage cost of the whole grid; P_{lo,m,j} represents the outage probability of a j^{th} node in the grid m; Nₗₒₛ represents the outage times of the power distribution network within a planning period; t represents the single outage lasting time; N represents the number of load nodes in each grid; S_{m,j} is the power supply state of a load node j in the grid m; 0 represents outage; 1 represents normal; P_{m,j}(t) is the power actually consumed by the load node j in the grid m at the moment t;

$${P}_{m , j} ( t ) = {P}_{den , m , j} ( t ) - {P}_{dis , m , j} ( t )$$

in the formula, P_{den,m,j}(t) represents the power demand of the load node j in the grid m at the moment t; P_{dis,m,j}(t) represents the power of a distributed resource of the load node j in the grid m at the moment t;
setting an inter-grid power interaction target function:

$${E}_{m , n} = \frac{{P}_{p} {\sum }_{i = 1}^{k} {P}_{s} \vert {P}_{ij} \vert + {P}_{q} {\sum }_{i = 1}^{k} {P}_{s} \vert {Q}_{ij} \vert}{{n}_{cl} - 1}$$

in the formula, Pᵢⱼ represents an active power flow of an inter-grid branch i; Qᵢⱼ represents an inactive power flow of the inter-grid branch i; k represents the number of inter-grid branches; and Pₚ and P_{q} represent power interaction coefficients.

As a preferable solution of the multi-target county power distribution network grid optimizing method of the present invention, solving the multi-target optimization model includes, expressing a mathematic model of a multi-target optimization problem as:

min F(x)=(C_{eco},C_{loc},E_{m,n})
introducing a Pareto dominance relation; giving two arbitrary decision variables xₗ and x₂ for m target functions ƒᵢ(x), i=1, 2, . . . ,m; if the following equation is met, regarding that the solution dominates

$$\{ \begin{matrix}{f}_{i} ( {x}_{1} ) \leq {f}_{i} ( {x}_{2} ) , ∀ i ∈ 1 , 2 , … , m , \\ {f}_{i} ( {x}_{1} ) < {f}_{i} ( {x}_{2} ) , ∃ i ∈ 1 , 2 , … , m ,\end{matrix}$$

the hunting strategy of whales is a process of constantly approaching to the optimal solution of the optimization problem, in which each whale can be regarded as a solution of the optimization problem, and the prey is regarded as an optimal solution to be obtained; solving the optimization problem by imitating the hunting process of whales is as follows;
surrounding prey: in the optimization problem, an individual with the best fitness function is regarded as an optimal individual of a population, and the process of other individuals in the population changing positions toward the optimal individual is expressed by a mathematical model as follows:

$$\{ \begin{matrix}\vec{x} ( t + 1 ) = \vec{{x}^{*}} ( t ) - A \vec{D} \\ \vec{D} = \vert C \vec{{x}^{*}} ( t ) - x ( t ) \vert\end{matrix}$$

In the formula, t represents the iterations at present; \vec{x}(t) represents the position of a whale at present; \vec{x*}(t) represents an optimal whale position obtained at present; \vec{x}(t+1) represents a whale position after position updating; \vec{D} represents the moving distance of the whale; A and C are correlation coefficients;

$$A = 2 a {R}_{1} - a , C = 2 {R}_{2} , a = 2 ( {t}_{max} - t ) / {t}_{max}$$

in the formula, R₁ and R₂ represent a random floating point number on [0, 1]; tₘₐₓ represents a set maximum iteration; a represents that a convergence factor is gradually reduced to 0 with increase of iterations;
bubble net hunting comprises spiral swimming: whales spirally swim towards the prey, which is expressed with a mathematic model as:

$$\{ \begin{matrix}\vec{x} ( t + 1 ) = \vec{{x}^{*}} ( t ) - \vec{{D}_{p}} {e}^{bl} cos ( 2 π l ) \\ \vec{{D}_{p}} = \vert \vec{{x}^{*}} ( t ) - \vec{x} ( t ) \vert\end{matrix}$$

In the formula, \vec{Dₚ} represents the distance between the whale and the optimal individual; b represents a constant for defining a spiral shape, generally as 1; and l is a random floating point number on (−1, 1).

As a preferable solution of the multi-target county power distribution network grid optimizing method of the present invention, the hunting strategy also includes introducing an action probability P to determine whether the whales choose to approach to the prey by means of contraction encircling or spiral swimming; individual whales choose contraction encircling when the generated random number is less than P and spiral swimming when the generated random number is not less than P; a mathematical model of whale bubble net hunting is as follows:

$$\vec{x} ( t + 1 ) = \{ \begin{matrix}\vec{{x}^{*}} ( t ) - A \vert C \vec{{x}^{*}} ( t ) - \vec{x} ( t ) \vert , p > P , \\ \vec{{x}^{*}} ( t ) + \vert \vec{{x}^{*}} ( t ) - \vec{x} ( t ) \vert {e}^{bl} cos ( 2 π l )\end{matrix}$$

in the formula, p represents a random floating point number on (0, 1); P represents an action probability constant, generally set as 0.5;
searching hunting: the whales globally search for the prey, and a mathematic model thereof is expressed as:

$$\{ \begin{matrix}\vec{x} ( t + 1 ) = \vec{{x}_{rand}} ( t ) - A \vec{D} \\ \vec{D} = \vert C \vec{{x}_{rand}} ( t ) - \vec{x} ( t ) \vert\end{matrix}$$

in the formula, \vec{x_{rand}}(t) represents a whale position randomly selected in the population; and
when A≥1, the whales randomly select individuals in the population for position updating, thereby enhancing the global search capability of the algorithm.

As a preferable solution of the multi-target county power distribution network grid optimizing method of the present invention, a mathematic model for grid information calculation is expressed as:

$$M = [ Grid \times \frac{{y}^{i} ( t ) - min Y ( t )}{max Y ( t ) - min Y ( y )} ]$$

in the formula, M represents the serial number of the grid of an individual; [·] represents the maximum integer smaller than the number in the bracket; Grid represents the number of grids to be divided; t represents iterations; y′(t) represents a target function value of an individual i of a t^{th} generation; max Y(t) represents the maximum value of a corresponding target function in all individuals of the population of the t^{th} generation; and min Y(+) represents the minimum value of the corresponding target function of all individuals of the population of the t^{th} generation;
obtaining a grid numbering tuple of all individuals; selecting the optimal individual by means of using a roulette method; and randomly selecting one of the individuals as the optimal individual when a selected grid has multiple individuals.

A multi-target county power distribution network grid optimizing system adopting the method of the present invention, including:
a first dividing unit, used for acquiring geographic information of the county region, and conducting the primary division of power supply grids;
a second dividing unit, used for conducting the secondary division of the power supply grids by means of using the K-means clustering algorithm; and
a third dividing unit, used for selecting the optimal planning strategy and conducting the third division of the power supply grids through the self-adaptive multi-target whale optimization algorithm.

A computer device, including: a memory and a processor; the memory is used for storing computer programs; and the steps of the county power distribution network gridding planning method based on the digital resource integration technology of the present invention are achieved when the computer programs are executed by the processor.

A computer readable storage medium, with computer programs stored thereon; and the steps of the county power distribution network gridding planning method based on the digital resource integration technology of the present invention are achieved when the computer programs are executed by the processor.

The present invention has the beneficial effects that the multi-target county power distribution network grid optimizing method provided by the present invention conducts the primary division of the power supply grids on the power grid digital platform according to mountains, water areas, traffic and geographical situations of different functional areas in the county region. Considering the structure of the power supply grids and net racks, the power supply scope of the transformer substation and the development situation of distributed resources after division, according to saturation load prediction results, the secondary division of the power supply grids is conducted by means of using the K-means clustering algorithm. With the targets of increasing the absorption and utilization rate of the distributed resources, reducing the planning cost, and improving the reliability of the county power distribution network, a multi-target collaboration planning model of the power distribution network is established, and an optimal planning strategy is selected and the third division of the power supply grids is conducted through a self-adaptive multi-target whale optimization algorithm. By studying the development and evolution mechanism of the county power distribution network in terms of time, space and resources, the planning and operation methods of the county power distribution network are combined to carry out resource digital integration, and conduct grid division of the county power distribution network. From the aspect of economy and safety, the multi-target collaboration planning model of the power distribution network is established, and an optimal planning scheme is selected.

### BRIEF DESCRIPTION OF DRAWINGS

To more clearly describe the technical solutions of the embodiments of the present invention, the accompanying drawings required to describe the embodiments are briefly described below. Apparently, the accompanying drawings described below are only some embodiments of the present invention. Those skilled in the art may further obtain other drawings based on these accompanying drawings without inventive effort. In the drawings:

FIG. 1 is an overall flow chat of a county power distribution network gridding planning method based on a digital resource integration technology provided by a first embodiment of the present invention;

FIG. 2 is a Pareto optimal frontier diagram of a county power distribution network gridding planning method based on a digital resource integration technology provided by a first embodiment of the present invention; and

FIG. 3 is a diagram of achieving steps of a multi-target grid optimization algorithm of a county power distribution network gridding planning method based on a digital resource integration technology provided by a second embodiment of the present invention.

### DETAILED DESCRIPTION OF THE EMBODIMENTS

In order to make the aforementioned purposes, features and advantages of the present invention more apparent and comprehensible, detailed descriptions of specific embodiments of the present invention are provided below in conjunction with the appended drawings. It is understood that the described embodiments are merely a part of the embodiments of the present invention, rather than all embodiments. Based on the embodiments of the present invention, all other embodiments obtained by those of ordinary skill in the art without creative efforts shall fall within the protection scope of the present invention.

### Embodiment 1

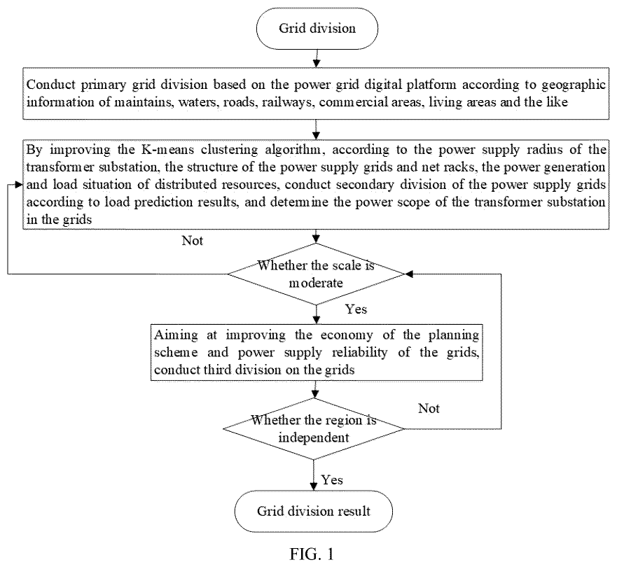

Referring to FIG. 1, as an embodiment of the present invention, providing a county power distribution network gridding planning method based on a digital resource integration technology, including:
S1: acquiring geographic information of a county region, and conducting primary division of power supply grids.

Further, the primary division includes conducting primary division of the power supply grids on a power grid digital platform according to mountains, water areas, traffic and geographical situations of different functional areas in a county region.

It should be noted that GIS data and functional area information collected are input into a system by means of using the power grid digital platform. On the power grid digital platform, according to geographic information and functional area features, power demands and power grid layout are simulated. The impact of natural obstacles such as mountains and waters on power grid construction, and the convenience of traffic network on power grid maintenance, are considered. According to simulation results, the primary division of the power supply grids is conducted. In this step, the reliability, economy and further expandability of the power grids need to be considered. The grids divided shall be able to effectively cover different functional areas, and meanwhile the limit of natural geographical conditions shall be considered.
S2: conducting secondary division of the power supply grids by means of using a K-means clustering algorithm.

It should be noted that the K-means algorithm is a clustering algorithm based on a target function, which is widely applied to data digging and machine learning. The algorithm is capable of carrying out rule regulation on the target function by means of using a method of calculating an extremum with function. The target function takes a distance as optimization. The algorithm aims to minimize evaluation functions, based on the criteria of a sum of squared errors, takes a Euclidean distance as similarity calculation, and classifies from an initial distance center. A criterion function conducts clustering with the sum of squared errors. When the number of clustering categories is known, the K-means algorithm can integrate orderless data into K category clusters through calculation, including all category data samples.

The K-means algorithm is a clustering algorithm based on a clustering number k, with the specific process as follows: first, randomly selecting k cluster centers, calculating the similarity of a data point to a cluster center, and distributing each data point to a closest cluster center. Secondly, re-calculating the central point of each cluster, re-calculating the similarity of the data point to the cluster center, and re-distributing the data point. The process iterates until the clustering results are stable and no longer change, and finally the cluster to which each data point belongs is obtained.

The steps are as follows:
step 1, determining a county region clustering number k according to a primary grid division result, with the geometric center (address of a transformer substation) of grids as the central point of each cluster;
step 2, determining classification conditions, namely taking power supply distances between a transformer substation and a load point and a distributed resource as classification conditions;
step 3, comparing each node with a closest clustering center according to a measuring mode of a power supply scope, and distributing into a closest cluster;
step 4, re-calculating data points in each cluster, namely the object mean of the nodes of each cluster, and simultaneously calculating the clustering result of all clusters; and
step 5, if the result value changes, repeating step 2, or else ending the algorithm, and outputting a secondary grid division result.

Further, the impact of distributed resource assess to the county power distribution network: the impact of source load operation features on the power distribution network is analyzed from three dimensions of source load type, source load distribution position and time dimension, power grid resources are digitally integrated, distributed resources are reasonably allocated, and the absorption rate is increased.
S3: selecting an optimal planning strategy, and conducting third division of the power supply grids through a self-adaptive multi-target whale optimization algorithm.

A county power network gridding multi-target coordination planning model is established, and the third division is achieved by solving the multi-target optimization model. Under the condition that the transformer substation sites and power supply scope thereof, as well as alternative main channel layout and load positions are obtained on the power grid digital platform, and independent connectivity of each grid channel and the maximum allowable transfer supply distance of the load are met, the maximum power supply partition number capable of achieving load transfer supply is taken as the target, and meanwhile, the total cost of grid investment is reduced as much as possible. A corresponding multi-target hybrid integer non-linear planning optimization model can be expressed as:

$${C}_{eco} = \text{?} ( ε {C}_{ij , m} + \text{?} ) + \text{?} [ ε \text{?} + \text{?} ) + \text{?} ] + \text{?} + {C}_{op} - {C}_{pro} + \text{?} \qquad ( 1 )$$

$$\text{?} \text{indicates text missing or illegible when filed}$$

In the formula, C_{eco} represents the total cost of grid planning investment; ε=k₁+k₂ and k₁ [symbol] k₂ are respectively coefficient of operation and maintenance cost and redemptory investment recovery coefficient; C_{ij,m} represents the total cost of the main line of an m^{th} interstation power supply grid, as the comprehensive cost of the whole line of all main lines; C_{th,n} represents the comprehensive cost of the main line of a self-loop power supply unit in an n^{th} non-interstation power supply grid; C_{fs,n} represents the comprehensive cost of the main line of a radiant power supply unit in the n^{th} non-interstation power supply grid; C_{ij,m}^{xy} represents the annual cost of main line power consumption of the m^{th} interstation power supply grid; C_{fij,n}^{xy} represents the annual cost of main line outage cost of the n^{th} non-supply grid; interstation power supply grid; Cᵢₙ represents the distributed resource investment construction cost; Cₒₚ represents the distributed resource operation maintenance cost; Cₚᵣₒ represents the distributed resource benefit; and Cₗ represents inter-grid digital communication investment.

The planning of digital communication is considered in steady grid division. A reasonable digital communication facility is beneficial to improvement of the grid control effect of the power distribution network. The digital communication facility consists of a data transmission line and a grid control unit. The digital communication facility is set as follows: the communication line is constructed along the power line, each node is equipped with a digital communication substation, and the communication substation is not far away from the transformer substation. The digital communication investment is set as:

$${C}_{l} = {p}_{l} {\sum }_{m = 1}^{N} {d}_{m} + {p}_{c} N \qquad ( 2 )$$

In the formula, N is the number of grids; and dₘ is the length of a branch line of a grid m. pₗ is the unit price of the data transmission line; and p_{c} is the unit price of the grid control unit.

What needs to be noted is that the reliability includes: along with access of the distributed resources, the overall reliability index of the power distribution network can be obtained by accumulating reliability indexes of different grids, and the outage cost is described as:

$${C}_{los} = {\sum }_{m = 1}^{N} {N}_{los} {\int }_{0}^{t} [ {\sum }_{n = 1}^{N} {P}_{lo , m , j} ( 1 - {S}_{m , j} ) {P}_{m , j} ( t ) ] dt \qquad ( 3 )$$

In the formula, Cₗₒₛ is a power distribution network reliability index, representing the total outage cost of the whole grid; P_{lo,m,j} is the outage probability of a j^{th} node in the grid m; Nₗₒₛ is the outage times of the power distribution network within a planning period; t is the single outage lasting time; N is the number of load nodes in each grid; S_{m,j} is the power supply state of a load node j in the grid m (0 represents outage, and 1 represents normal); and P_{m,j}(t) is the power actually consumed by the load node j in the grid m at the moment t.

In view of the self-healing ability of the grids after county power distribution network gridding, faults can be actively isolated in case of faults, and self-healing can be achieved by means of using distributed resources. The actual consumption power P_{m,j}(t) of each node in the fault recovering period can be further described as:

$${P}_{m , j} ( t ) = {P}_{den , m , j} ( t ) - {P}_{dis , m , j} ( t ) \qquad ( 4 )$$

In the formula: P_{dem,m,j}(t) is the power demand of the load node j in the grid m at the moment t; and P_{dts,m,j}(t) is the power of a distributed resource of the load node j in the grid m at the moment t.

Inter-grid power interaction includes, if the power interaction of grids is the lowest, the coordinated dispatching of the power grid can be easier in actual operation of the power grid. Therefore, an inter-grid power interaction target function is set as:

$${E}_{m , n} = \frac{{P}_{p} {\sum }_{i = 1}^{k} {P}_{s} \vert {P}_{ij} \vert + {P}_{q} {\sum }_{i = 1}^{k} {P}_{s} \vert {Q}_{ij} \vert}{{n}_{cl} - 1} \qquad ( 5 )$$

In the formula, Pᵢⱼ and Qᵢⱼ are respectively an active power flow and an inactive power flow of an inter-grid branch i; k is the number of inter-grid branches; and Pₚ and P_{q} are power interaction coefficients.

What needs to be noted is that constraint conditions include:

Power distribution network flow constraint:

$$\{ \begin{matrix}{P}_{max , i} > {P}_{i} = {U}_{i} {\sum }_{j = 1}^{M} {U}_{j} ( {G}_{ij} cos {θ}_{ij} + {B}_{ij} sin {θ}_{ij} ) \\ {Q}_{max , i} > {Q}_{i} = {U}_{i} {\sum }_{j = 1}^{M} {U}_{j} ( {G}_{ij} cos {θ}_{ij} + {B}_{ij} sin {θ}_{ij} )\end{matrix} \qquad ( 6 )$$

In the formula, Pᵢ and Qᵢ are respectively the active power and the inactive power of a node i; P_{max,i} and Q_{max,i} are respectively the maximum allowable values of the active power and the inactive power of the node i; Uᵢ and Uⱼ are respectively voltages of the nodes i and j; and Bᵢⱼ are Gᵢⱼ respectively the conductivity and electrical susceptance between the nodes i and j; and θᵢⱼ is a voltage phase angle between the nodes i and j.

Node voltage constraint conditions.

$${U}_{i , min} \leq {U}_{i} \leq {U}_{i , max} \qquad ( 7 )$$

In the formula, U_{i,min} and U_{i,max} are respectively the lower limit value and the upper limit value of the voltage of a node i.

Solving the multi-target optimization model: a mathematic model of a multi-target optimization problem is expressed as:

$$min F ( x ) = ( {C}_{eco} , {C}_{los} , {E}_{m , n} ) \qquad ( 8 )$$

The purpose of multi-target optimization is to find an optimal solution. But in actual application, the target functions are contradictory, that is, the cost of optimizing one target function is to degrade other target functions, and an ideal state of resource distribution is hard to achieve. In addition, such ideal state generally has multiple solutions, and how to find all such solution sets in a solution space is the main problem to be solved by the multi-target optimization algorithm.

To solve the problem of multi-target optimization, first the concept of Pareto dominance relation should be introduced; two arbitrary decision variables x₁ and x₂ for m target functions ƒ(x),i=1, 2 . . . , m are given; and if the Formula (9) is met, it regards that the solution x₁ dominates x₂.

$$\{ \begin{matrix}\text{?} ( {x}_{1} ) \leq \text{?} ( {x}_{2} ) , ∀ i ∈ 1 , 2 , … , m , \\ \text{?} ( {x}_{1} ) < \text{?} ( {x}_{2} ) , ∀ i ∈ 1 , 2 , … , m ,\end{matrix} \qquad ( 9 )$$

$$\text{?} \text{indicates text missing or illegible when filed}$$

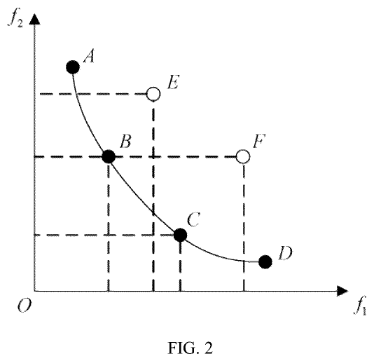

As shown in FIG. 2, set that the smaller the target functions ƒ₁ and ƒ₂, the better, and A, B, C, D, E and F are six solutions in a target space. B is prior to E on two target functions, it can be called that B dominates E according to Formula (2), similarly, it can be concluded that C dominates F, and for A and D, since there is no solution dominating in the solution space, a hypersurface of A, B, C and D forms the Pareto frontier as shown in the curve in the figure in the solution space at present.

Therefore, if no other decision variable can dominate one decision variable, such decision variable is called a non-dominated solution. Non-dominated sequencing is to put solutions meeting the condition in all decision variables into a set, solution sets forming the Pareto frontier are marked as a first layer, then all non-dominated solution sets found are excluded and non-dominated sequencing is conducted on the remaining individuals again, solution sets of the Pareto frontier obtained are marked as a second layer, and so on until all individuals in a population are processed.

Further, the whale optimization algorithm simulates the hunting process of whales in nature: after finding the prey, the whales surround the prey in groups, spirally swim to the target and constantly spit out bubbles in the process, forming a kind of column “bubble net” to tightly surround the prey in the center until the whales are close to swallow. The hunting strategy of whales is a process of constantly approaching to the optimal solution of the optimization problem, in which each whale can be regarded as a solution of the optimization problem, and the prey can be regarded as an optimal solution to be obtained, therefore, the optimization problem can be solved by imitating the hunting process of whales as follows:

Surrounding prey: whales are social animals, and as soon as one member of the group spots the prey, other individuals will move towards to grab. In the optimization problem, an individual with the best fitness function is regarded as an optimal individual of the population, and the process of other individuals in the population changing positions toward the optimal individual is expressed by a mathematical model as follows:

$$\{ \begin{matrix}\vec{x} ( t + 1 ) = \vec{{x}^{*}} ( t ) - A \vec{D} \\ \vec{D} = \vert C \vec{{x}^{*}} ( t ) - \vec{x} ( t ) \vert\end{matrix} \qquad ( 10 )$$

In the formula, t is the iterations at present; \vec{x}(t) is the position of a whale at present; \vec{x}*(t) is an optimal whale position obtained at present; \vec{x}(t+1) is a whale position after position updating; and \vec{D} is the moving distance of the whale. A and C are correlation coefficients, as shown in Formula (11):

$$A = 2 {aR}_{1} - a , C = 2 {R}_{2} , a = 2 ( {t}_{max} - t ) / {t}_{max} \qquad ( 11 )$$

In the formula, R₁ and R₂ are random floating point numbers on [0, 1]; tₘₐₓ is a set maximum iteration; and a is that a convergence factor is gradually reduced to 0 with increase of iterations.

“Bubble net” hunting: whales throw up “bubble nets” to surround the prey during hunting, so two mathematical models are designed to represent the hunting behavior. Contraction encircling. Approach to the prey by continuously encircling through Formula (3). The difference from Formula (3) lies in the value range of A. Since the whale only sends “bubble nets” to trap the prey when being close to the prey, and A gradually decreases with the increase of iterations, when A<1 is set, the updated position of the whale can be anywhere between it and the optimal individual.

Spiral swimming: whales spirally swim towards the prey, which is expressed with a mathematic model as:

$$\{ \begin{matrix}\vec{x} ( t + 1 ) = \vec{{x}^{*}} ( t ) - \vec{{D}_{p}} {e}^{bl} cos ( 2 π l ) \\ \vec{{D}_{p}} = \vert \vec{{x}^{*}} ( t ) - \vec{x} ( t ) \vert\end{matrix} \qquad ( 12 )$$

In the formula, \vec{Dₚ} represents the distance between the whale and the optimal individual; b represents a constant for defining a spiral shape, generally as 1; and l is a random floating-point number on (−1, 1).

The two hunting behaviors occur during different whale hunts, and to better simulate the asynchrony of behaviors, an action probability P is introduced to determine whether the whales choose to approach to the prey by means of contraction encircling or spiral swimming; individual whales choose contraction encircling when the generated random number is less than P and spiral swimming when the generated random number is not less than P; and therefore the mathematical model for whale “bubble net” hunting is as follows:

$$\vec{x} ( t + 1 ) = \{ \begin{matrix}\vec{{x}^{*}} ( t ) - A \vert C \vec{{x}^{*}} ( t ) - \vec{x} ( t ) \vert , p > P , \\ \vec{{x}^{*}} ( t ) + \vert \vec{{x}^{*}} ( t ) - \vec{x} ( t ) \vert {e}^{bl} cos ( 2 π l )\end{matrix} \qquad ( 13 )$$

In the formula, p is a random floating point number on (0, 1); and P represents an action probability constant, generally set as 0.5.

Searching hunting, the whales globally search for the prey, and a mathematic model thereof is expressed as:

$$\{ \begin{matrix}\vec{x} ( t + 1 ) = \vec{{x}_{rand}} ( t ) - A \vec{D} \\ \vec{D} = \vert C \vec{{x}_{rand}} ( t ) - \vec{x} ( t ) \vert\end{matrix} \qquad ( 14 )$$

In the formula, x_{\vec{rand}}(t) is a whale position randomly selected in the population; and when A≥1, the whales randomly select individuals in the population for position updating, thereby enhancing the global search capability of the algorithm.

Further, the optimal individual is selected. A conventional single-target whale optimization algorithm can select the optimal individual according to a fitness function value, but a population with multiple target functions often has multiple optimal individuals. Criteria for selecting a leading whale group updating position are one of the important problems in the design of multi-target whale optimization algorithm.

At present, most multi-target optimization algorithms can sequence the advantages and disadvantages of non-dominated solution sets by calculating the crowding degree among individuals, but the calculation process is complicated and not conducive to the global search of the algorithm, so a method based on self-adaptive grid division is chosen to select the optimal individual. The grid density can be used to describe the number of individuals contained in each region of the target space. The more the individuals in the region, the greater the grid density. The fewer the individuals, the smaller the grid density. To maintain the diversity of population individuals, individuals in the region with smaller grid density are more likely to be selected as the best individuals. Taking a target function 1 as an example, a mathematical model of a grid information calculation method is shown in Formula (15).

$$M = [ Grid \times \frac{{y}^{i} ( t ) - min Y ( t )}{max Y ( t ) - min Y ( y )} ] \qquad ( 15 )$$

In the formula, M represents the serial number of grids of an individual; [⋅] represents the maximum integer smaller than the number in the bracket; Grid is the number of grids to be divided; t is iterations; yⁱ(t) is a target function value of an individual i of a t^{th} generation; max Y(t) is the maximum value of a corresponding target function in all individuals of the population of the t^{th} generation; and min Y(+) is the minimum value of the corresponding target function of all individuals of the population of the t^{th} generation.

A grid numbering tuple of all individuals is obtained through Formula (15); the optimal individual is selected by means of using a roulette method; the more individuals in the same numbered group, the larger the grid density, and the lower the probability of selecting an individual in the grid as the optimal individual; and one of the individuals is randomly selected as the optimal individual when a selected grid has multiple individuals.

What needs to be noted is that a Pareto external file is introduced into a population intelligent algorithm to store a non-dominated solution generated in the population iteration process. When individuals in the external file exceed the value set in advance, excessive individuals need to be deleted according to the corresponding strategy to maintain the superiority of the individual in the external file. Based on the idea, when the non-dominated solution stored in the external file exceeds the set value, the grid density of different individuals can be used as the evaluation criteria to process the external file, and individuals with large grid density can be deleted from the file until the number of individuals in the external file meets the requirements.

On the other hand, the embodiment also provides a multi-target county power distribution network grid optimizing system, including:
a first dividing unit, used for acquiring geographic information of the county region, and conducting primary division of power supply grids;
a second dividing unit, used for conducting secondary division of the power supply grids by means of using the K-means clustering algorithm; and
a third dividing unit, used for selecting the optimal planning strategy and conducting the third division of the power supply grids through the self-adaptive multi-target whale optimization algorithm.

The above functions, if implemented in the form of software functional units and sold or used as stand-alone products, can be stored in a computer readable storage medium. Based on this understanding, the technical solution of the present invention essentially or a part that contributes to the prior art; or part of the technical solution may be embodied in a form of a software product; and the computer software product is stored in a storage medium and includes a plurality of instructions which are used to enable a computer device (which may be a personal computer, a server, or a network device, etc.) to execute all or part of the steps of the methods described in the various embodiments of the present invention. The storage medium includes: a USB flash disk, a mobile hard disk, a read-only memory (ROM), a random access memory (RAM), a magnetic disk or an optical disk and another medium that can store program codes.

Logics and/or steps expressed in the flow chart or otherwise described herein, for example, may be considered as a sequence table of executable instructions for implementing logical functions, and may be implemented in any computer-readable medium for use by instruction execution systems, apparatuses, or devices (such as computer-based systems, systems including processors, or other systems that may acquire instructions from the instruction execution systems, the apparatuses, or the devices and execute the instructions), or in a combination manner. For the purposes of this specification, the “computer-readable medium” may be any device that may contain, store, communicate, propagate or transmit a program for use by the instruction execution systems, the apparatuses, or the devices or in a combination manner.

More specific examples of the machine-readable storage medium (non-exhaustive list) may include an electrical connection (an electronic apparatus) with one or more wires, a portable computer disk case (a magnetic apparatus), a random access memory (RAM), a read-only memory (ROM), an erasable programmable read-only memory (EPROM or flash memory), an optical fiber, and a portable compact disk read-only memory (CDROM). In addition, the computer-readable medium may even be paper or other appropriate media on which the program may be printed. It because that the program may be acquired electronically, for example, by optically scanning the paper or other media, followed by editing, interpretation or, if necessary, other appropriate processing ways, and then stored in a computer memory.

It should be understood that each part of the present invention can be achieved by hardware, software, firmware or a combination thereof. In the above implementation, multiple steps or methods can be implemented with the software or the firmware stored in the memory and executed by the appropriate instruction execution system. For example, if they are implemented by the hardware, as in another implementation, they may be implemented by any one of the following technologies well known in the art or their combination: a discrete logic circuit with a logic gate circuit for implementing a logic function of a data signal, a special integrated circuit with an appropriate combinational logic gate circuit, a programmable gate array (PGA), a field programmable gate array (FPGA), etc.

### Embodiment 2

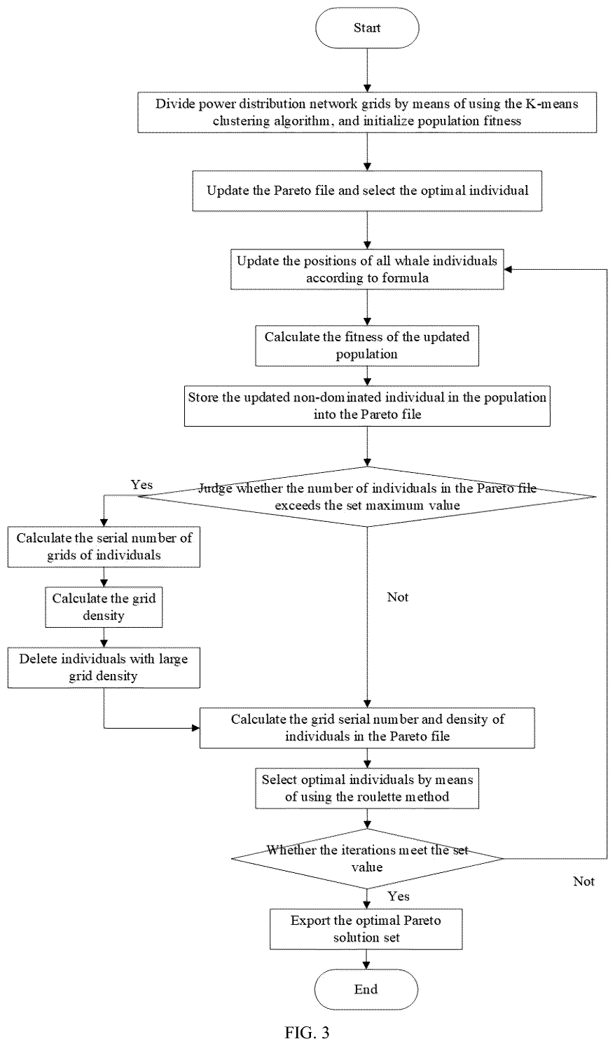

Referring to FIG. 3, as an embodiment of the present invention, providing the county power distribution network gridding planning method based on the digital resource integration technology, and to verify the beneficial effect of the present invention, scientific demonstration is carried out through economic benefit calculation and simulation experiments.

Achieving steps of the multi-target grid optimization algorithm, are shown in FIG. 3.
(1) Initializing the fitness of the population by the results of the second grid division.
(2) Updating the Pareto file and selecting an optimal individual.
(3) Updating the positions of all whale individuals according to formulae.
(4) Calculating the fitness of the updated population.
(5) Storing the updated non-dominated individual in the population into the Pareto file.
(6) If the number of individuals in the Pareto file exceeds the set maximum value, calculating the serial number of the grid of the individual, calculating the grid density, and deleting individuals with large grid density.
(7) Calculating the grid serial number and density of individuals in the Pareto file.
(8) Selecting optimal individuals by means of using the roulette method.
(9) If the iterations meet the set value, carrying out a next step. Or else, jumping to step (3).
(10) Exporting the optimal Pareto solution set. As the result of the third grid division.

Through the comparative test of random scenes, the same scenes are selected and divided respectively by the present invention and a conventional method. Test results are shown in Table 1.

| | | The | |
|---|---|---|---|
| | Conventional | present | Improvement |
| Evaluation index | method | invention | percent |
| Planning accuracy (%) | 75 | 95 | +26.7% |
| Power supply reliability | 99.9334 | 99.9812 | 0.047% |
| Line communication rate (%) | 87.83 | 100 | 12.17% |
| Inter-station communication | 86.72 | 93 | 7.2% |
| rate (%) | | | |
| Line power supply radius | 90.13 | 100 | 10.9% |
| standard rate (%) | | | |
| Annual cost of medium voltage | 2005.68 | 1760.42 | −12% |
| power cable (ten thousand yuan) | | | |
| Environmental influence (carbon | 1011 | 731 | −27.7% |
| emission, ton) | | | |

Table 1 shows that the present invention improves the accuracy of power supply grid division, thus ensuring effective distribution and utilization of resources. Unnecessary construction and maintenance cost are reduced, and higher economic benefits are achieved. The optimized grid design and resource allocation improve the overall reliability of the system, and the frequency of faults is reduced. Rapid adjustment and expansion are supported, enabling the power distribution network to flexibly correspond to future change and demand. Through planning of grid optimization, energy consumption and carbon emission in the construction and maintenance process are reduced, being beneficial to environment protection and sustainable development.

It should be noted that the above examples are merely used to explain the technical solutions of the present invention and not intended to limit the present disclosure. Although the present invention is described in detail with reference to the preferred examples, those of ordinary skill in the art should understand that they can make modifications or equivalent substitutions to the technical solutions of the present invention without departing from the spirit and scope of the technical solutions of the present invention. These modifications or equivalent substitutions should fall within the scope of the claims of the present invention.

What is claimed is:

1. A county power distribution network gridding planning method based on a digital resource integration technology, comprising:
acquiring geographic information of a county region, and conducting primary division of power supply grids;
conducting secondary division of the power supply grids by means of using a K-means clustering algorithm; and
selecting an optimal planning strategy and conducting third division of the power supply grids through a self-adaptive multi-target whale optimization algorithm.

2. The county power distribution network gridding planning method based on the digital resource integration technology according to claim 1, wherein the primary division comprises conducting primary division of the power supply grids on a power grid digital platform according to mountains, water areas, traffic and geographical situations of different functional areas in a county region.

3. The county power distribution network gridding planning method based on the digital resource integration technology according to claim 1, wherein the K-means clustering algorithm comprises determining a county region clustering number k according to a primary grid division result, with the geometric center of grids as the central point of each cluster;
determining classification conditions, namely taking power supply distances between a transformer substation and a load point and a distributed resource as classification conditions;
comparing each node with a closest clustering center according to a measuring mode of a power supply scope, and distributing into a closest cluster;
re-calculating data points in each cluster, namely the object mean of the nodes of each cluster, and simultaneously calculating the clustering result of all clusters; and
if the result value changes, repeating the step of determining classification conditions, or else ending the algorithm, and outputting a secondary grid division result.

4. The county power distribution network gridding planning method based on the digital resource integration technology according to claim 3, wherein the third division comprises establishing a county power distribution network gridding multi-target coordination planning model, and solving the multi-target optimization model to achieve the third division;
the county power distribution network gridding multi-target coordination planning model comprises the total cost of grid planning investment:
$${C}_{eco} = \text{?} ( ε {C}_{ij , m} + \text{?} ) + \text{?} [ ( ε \text{?} + \text{?} ) + \text{?} ] + \text{?} + {C}_{op} - {C}_{pro} = {C}_{l}$$
$$\text{?} \text{indicates text missing or illegible when filed}$$
in the formula, C_{eco} represents the total cost of grid planning investment; ε=k₁+k₂ and k₁ [symbol] k₂ are respectively coefficient of operation and maintenance cost and redemptory investment recovery coefficient; C_{ij,m} represents the total cost of the main line of an m^{th} interstation power supply grid, as the comprehensive cost of the whole line of all main lines; C_{th,n} represents the comprehensive cost of the main line of a self-loop power supply unit in an n^{th} non-interstation power supply grid; C_{fs,n} represents the comprehensive cost of the main line of a radiant power supply unit in the n^{th} non-interstation power supply grid; C_{ij,m}^{xy} represents the annual cost of main line power consumption of the m^{th} interstation power supply grid; C_{fij,n}^{xy} represents the annual cost of main line outage cost of the n^{th} non-interstation power supply grid; Cᵢₙ represents the distributed resource investment construction cost; Cₒₚ represents the distributed resource operation maintenance cost; Cₚᵣₒ represents the distributed resource benefit; Cₗ represents inter-grid digital communication investment;
$${C}_{l} = {p}_{l} {\sum }_{m = 1}^{N} {d}_{m} + {p}_{c} N$$
setting that a communication line is constructed along a power line, each node is equipped with a digital communication substation, and the communication substation is not far away from the transformer substation; setting the digital communication investment as:
in the formula, N represents the number of grids; dₘ represents the length of a branch line of a grid m; pₗ represents the unit price of a data transmission line; p_{c} represents the unit price of a grid control unit;
the outage cost describes a power distribution network overall reliability index, expressed as:
$${C}_{los} = {\sum }_{m = 1}^{N} {N}_{los} {\int }_{0}^{t} [ {\sum }_{n = 1}^{N} {P}_{lo , m , j} ( 1 - {S}_{m , j} ) {P}_{m , j} ( t ) ] dt$$
in the formula, Cₗₒₛ is a power distribution network reliability index, representing the total outage cost of the whole grid; P_{lo,m,j} represents the outage probability of a j^{th} node in the grid m; Nₗₒₛ represents the outage times of the power distribution network within a planning period; t represents the single outage lasting time; N represents the number of load nodes in each grid; S_{m,j} is the power supply state of a load node j in the grid m; 0 represents outage; 1 represents normal; P_{m,j}(t) is the power actually consumed by the load node j in the grid m at the moment t;
$${P}_{m , j} ( t ) = {P}_{den , m , j} ( t ) - {P}_{dis , m , j} ( t )$$
in the formula, P_{den,m,j}(t) represents the power demand of the load node j in the grid m at the moment t; P_{dis,m,j}(t) represents the power of a distributed resource of the load node j in the grid m at the moment t;
setting an inter-grid power interaction target function:
$${E}_{m , n} = \frac{{P}_{p} {\sum }_{i = 1}^{k} {P}_{s} \vert {P}_{ij} \vert + {P}_{q} {\sum }_{i = 1}^{k} {P}_{s} \vert {Q}_{ij} \vert}{{n}_{cl} - 1}$$
in the formula, Pᵢⱼ represents an active power flow of an inter-grid branch i; Qᵢⱼ represents an inactive power flow of the inter-grid branch i; k represents the number of inter-grid branches; and Pₚ and P_{g} represent power interaction coefficients.

5. The county power distribution network gridding planning method based on the digital resource integration technology according to claim 4, wherein solving the multi-target optimization model comprises, expressing a mathematic model of a multi-target optimization problem as:
min F(x)=(C_{eco},Cₗₒₛ,E_{m,n})
introducing a Pareto dominance relation; giving two arbitrary decision variables x₁ and x₂ for m target functions ƒ(x), i=1, 2, . . . , m; if the following equation is met, regarding that the solution x₁ dominates x₂;
$$\{ \begin{matrix}{f}_{i} ( {x}_{1} ) \leq {f}_{i} ( {x}_{2} ) , ∀ i ∈ 1 , 2 , … , m , \\ {f}_{i} ( {x}_{1} ) \leq {f}_{i} ( {x}_{2} ) , ∃ i ∈ 1 , 2 , … , m ,\end{matrix}$$
the hunting strategy of whales is a process of constantly approaching to the optimal solution of the optimization problem, in which each whale can be regarded as a solution of the optimization problem, and the prey is regarded as an optimal solution to be obtained; solving the optimization problem by imitating the hunting process of whales is as follows;
surrounding prey: in the optimization problem, an individual with the best fitness function is regarded as an optimal individual of a population, and the process of other individuals in the population changing positions toward the optimal individual is expressed by a mathematical model as follows:
$$\{ \begin{matrix}\vec{x} ( t + 1 ) = \vec{{x}^{*}} ( t ) - A \vec{D} \\ \vec{D} = \vert C \vec{{x}^{*}} ( t ) - \vec{x} ( t ) \vert\end{matrix}$$
in the formula, t represents the iterations at present; \vec{x}(t) represents the position of a whale at present; \vec{x}*(t) represents an optimal whale position obtained at present; \vec{x}(t+1) represents a whale position after position updating; \vec{D} represents the moving distance of the whale; A and C are correlation coefficients;
$$A = 2 {aR}_{1} - a , C = 2 {R}_{2} , a = 2 ( {t}_{max} - t ) / {t}_{max}$$
in the formula, R₁ and R₂ represent a random floating point number on [0, 1]; tₘₐₓ represents a set maximum iteration; a represents that a convergence factor is gradually reduced to 0 with increase of iterations;
bubble net hunting comprises spiral swimming: whales spirally swim towards the prey, which is expressed with a mathematic model as:
$$\{ \begin{matrix}\vec{x} ( t + 1 ) = \vec{{x}^{*}} ( t ) - \vec{{D}_{p}} {e}^{bl} cos ( 2 π l ) \\ \vec{{D}_{p}} = \vert \vec{{x}^{*}} ( t ) - \vec{x} ( t ) \vert\end{matrix}$$
in the formula, \vec{Dₚ} represents the distance between the whale and the optimal individual; b represents a constant for defining a spiral shape, generally as 1; and l is a random floating point number on (−1, 1).

6. The multi-target county power distribution network grid optimizing method according to claim 5, wherein the hunting strategy also comprises introducing an action probability P to determine whether the whales choose to approach to the prey by means of contraction encircling or spiral swimming; individual whales choose contraction encircling when the generated random number is less than P and spiral swimming when the generated random number is not less than P; a mathematical model of whale bubble net hunting is as follows:
$$\vec{x} ( t + 1 ) = \{ \begin{matrix}\vec{{x}^{*}} ( t ) - A \vert C \vec{{x}^{*}} ( t ) - \vec{x} ( t ) \vert , p > P , \\ \vec{{x}^{*}} ( t ) + \vert \vec{{x}^{*}} ( t ) - \vec{x} ( t ) \vert {e}^{bl} cos ( 2 π l )\end{matrix}$$
in the formula, p represents a random floating point number on (0, 1); P represents an action probability constant, generally set as 0.5;
searching hunting: the whales globally search for the prey, and a mathematic model thereof is expressed as:
$$\{ \begin{matrix}\vec{x} ( t + 1 ) = \vec{{x}_{rand}} ( t ) - A \vec{D} \\ \vec{D} = \vert C \vec{{x}_{rand}} ( t ) - \vec{x} ( t ) \vert\end{matrix}$$
in the formula, x_{\vec{rand}}(t) represents a whale position randomly selected in the population; and
when A≥1, the whales randomly select individuals in the population for position updating, thereby enhancing the global search capability of the algorithm.

7. The county power distribution network gridding planning method based on the digital resource integration technology according to claim 6, wherein a mathematic model for calculating grid information is expressed as:
$$M = [ Grid \times \frac{{y}^{i} ( t ) - min Y ( t )}{max Y ( t ) - min Y ( y )} ]$$
in the formula, M represents the serial number of the grid of an individual; [⋅] represents the maximum integer smaller than the number in the bracket; Grid represents the number of grids to be divided; t represents iterations; yⁱ(t) represents a target function value of an individual i of a t^{th} generation; max Y(t) represents the maximum value of a corresponding target function in all individuals of the population of the t^{th} generation; and min Y(t) represents the minimum value of the corresponding target function of all individuals of the population of the t^{th} generation;
obtaining a grid numbering tuple of all individuals; selecting the optimal individual by means of using a roulette method; and randomly selecting one of the individuals as the optimal individual when a selected grid has multiple individuals.

8. A system adopting the county power distribution network gridding planning method based on the digital resource integration technology according to claim 1, comprising:
a first dividing unit, used for acquiring geographic information of the county region, and conducting the primary division of power supply grids;
a second dividing unit, used for conducting the secondary division of the power supply grids by means of using the K-means clustering algorithm; and
a third dividing unit, used for selecting the optimal planning strategy and conducting the third division of the power supply grids through the self-adaptive multi-target whale optimization algorithm.

9. A computer device, comprising: a memory and a processor, wherein the memory is used for storing computer programs; and the steps of the multi-target county power distribution network grid optimizing method is achieved when the computer programs are executed by the processor.

10. A computer readable storage medium, with computer programs stored thereon, wherein the steps of the multi-target county power distribution network grid optimizing method is achieved when the computer programs are executed by the processor.
